(19) United States
(12) Patent Application Publication
(10) Pub. No.: US 2007/0058913 A1
(43) Pub. Date: Mar. 15, 2007

(54) Method for the production of an optical transmission element comprising a filled chamber element and otpical transmission element

(76) Inventors: Horst Knoch, Coburg (DE); Dieter Erwin Kundis, Lautertal (DE)

Correspondence Address: Michael E Carroll Jr, PO Box 489, Hickory, NC, 28603-0489, US

(21) Appl. No.: 10/571,987

(22) PCT Filed: Sep. 7, 2004
(86) PCT No.: PCT/DE04/01986

§ 371 Date: Mar. 10, 2006

(30) Foreign Application Priority Data
Sep. 12, 2003 (DE) 10342319.2

(51) Int. Cl. G02B 6/44

(52) U.S. Cl. 385/100; 385/109

(57) ABSTRACT

The invention relates to a method for the production of an optical transmission element comprising at least one optical waveguide and comprising a chamber element surrounding the optical waveguide and enclosing an internal space. A foamed filler composition is applied discontinuously to the optical waveguide and the optical waveguide is subsequently supplied to an extruder, the latter forming a chamber element around the optical waveguide. The filler composition stabilizes within the chamber element formed and, in the final state, forms a plurality of dry compressible filler elements, each surrounding the optical waveguide. A dry and readily manipulable optical transmission element is thus present. A discharge of filler composition and an escape of the optical waveguides from the transmission element are prevented.

### FIELD OF THE INVENTION

The present invention relates to a method for the production of an optical transmission element comprising at least one optical waveguide and comprising a filled chamber element surrounding the optical waveguide. The invention furthermore relates to an optical transmission element of this type.

### BACKGROUND OF THE INVENTION

Optical transmission elements such as optical cables or optical cores, for example in the form of so-called bundle cores, generally contain one or a plurality of optical waveguides surrounded by a chamber element enclosing the latter. One customary method of fixing the optical waveguides in an optical transmission element is to fill the chamber element with highly viscous, thixotropic or crosslinking filler composition. Water that penetrates into the chamber tube in the event of damage to the transmission element is prevented from advancing further by the filler composition. A filler composition of this type has the disadvantage that it can run out or drip out for instance in the case of perpendicularly hanging ends of the transmission element. Moreover, filler composition that emerges in the case of the separation of the transmission element during installation may lead to contamination and handling problems on the part of the assembly personnel.

The problem of the discharge of the filler composition could be combated with a crosslinking silicone filler composition on a two-component basis. This has the disadvantage, however, that the production process is beset with comparatively high costs and a degree of manufacturing uncertainty on account of the components used for this purpose.

### SUMMARY OF THE INVENTION

The present invention is based on the object of specifying a method for the production of an optical transmission element by means of which a readily manipulable optical transmission element comprising a filled chamber element can be produced in an effective manner.

Furthermore, it is an object of the present invention to specify a corresponding optical transmission element.

This object is achieved by means of a method for the production of an optical transmission element in accordance with the invention and by means of an optical transmission element according to the invention.

According to the method according to the invention, a filler composition is applied discontinuously in the foamed state to the optical waveguide supplied to an extruder. The optical waveguide with the applied prefoamed filler composition is subsequently supplied to the extruder, the latter forming a chamber element around the optical waveguide. The applied filler composition stabilizes within the chamber element formed by virtue of the supply of heat to the chamber element, the filler composition filling existing interspaces in the internal space in the cross-sectional plane of the transmission element and, in the final state, a plurality of dry compressible filler elements being formed, each surrounding the optical waveguide.

The end product that thus arises is an optical transmission element comprising an optical waveguide and a chamber element surrounding the optical waveguide, in which a plurality of dry and compressible filler elements are arranged in the internal space of the chamber element, said filler elements being formed by prefoamed material in the internal space. The filler elements in the prefoamed state exert a defined press-on force against the chamber element and against the optical waveguide in order to fix the same in the longitudinal direction of the transmission element, positional changes of the optical waveguide nevertheless being made possible. The filler elements each surround the optical waveguide, and existing interspaces between the optical waveguide and the chamber element in the cross-sectional plane of the transmission element are filled by the subsequently stabilizing filler composition which still expands slightly. Moreover, the filler elements make contact with the optical waveguide and the chamber element essentially in a positively locking manner. A dry and readily manipulable optical transmission is thus present. A discharge of filler composition and an escape of the optical waveguides from the transmission element are prevented.

Preferably, the foamed filler composition, upon introduction into the extruder has a diameter that is approximately equal to an internal diameter of the chamber element. As a result, the method according to the invention advantageously does not impair the cross section of the extruded chamber element during the stabilization process of the filler composition.

This is furthermore achieved by virtue of the fact that the prefoamed filler composition, during the extrusion of the chamber element, is still arranged comparatively compactly and compliantly on the optical waveguide and only after introduction into the extruder does it still expand slightly within the chamber element formed, in order to produce a positively locking fit with respect to the chamber element. Preferably, the foamed filler composition expands by approximately 10 percent of its volume after introduction into the extruder. As a result, after extrusion the chamber element can firstly cure to a large extent before the filler composition makes contact with the inner wall of the chamber element. By way of example, polyurethanes or silicones may be used as the filler composition.

Advantageously, at least two nozzles are used which apply the foamed filler composition uniformly to the optical waveguide approximately concentrically and in the radial direction of the transmission element. This largely ensures that the filler elements each completely surround the optical waveguide and the filler composition fills existing interspaces between the optical waveguide and the chamber element in the cross-sectional plane of the transmission element.

In order to improve this process still further, preferably more than two nozzles are used which are arranged in star-type fashion in the radial direction of the transmission element and enclose the optical waveguide between them.

Further advantageous designs and developments of the invention are specified in the subclaims.

The invention is explained in more detail below with reference to the figures that are illustrated in the drawing and illustrate exemplary embodiments of the present invention.

### BRIEF DESCRIPTION OF THE DRAWINGS

In the figures:

FIG. 1 schematically shows a production line for the production of an optical transmission element according to the invention,

FIG. 2 shows a longitudinal section through an optical transmission element according to the invention in the final state,

FIG. 3 shows a further embodiment of a device for the production of an optical transmission element according to the method according to the invention, in cross section.

### DETAILED DESCRIPTION OF THE DRAWINGS

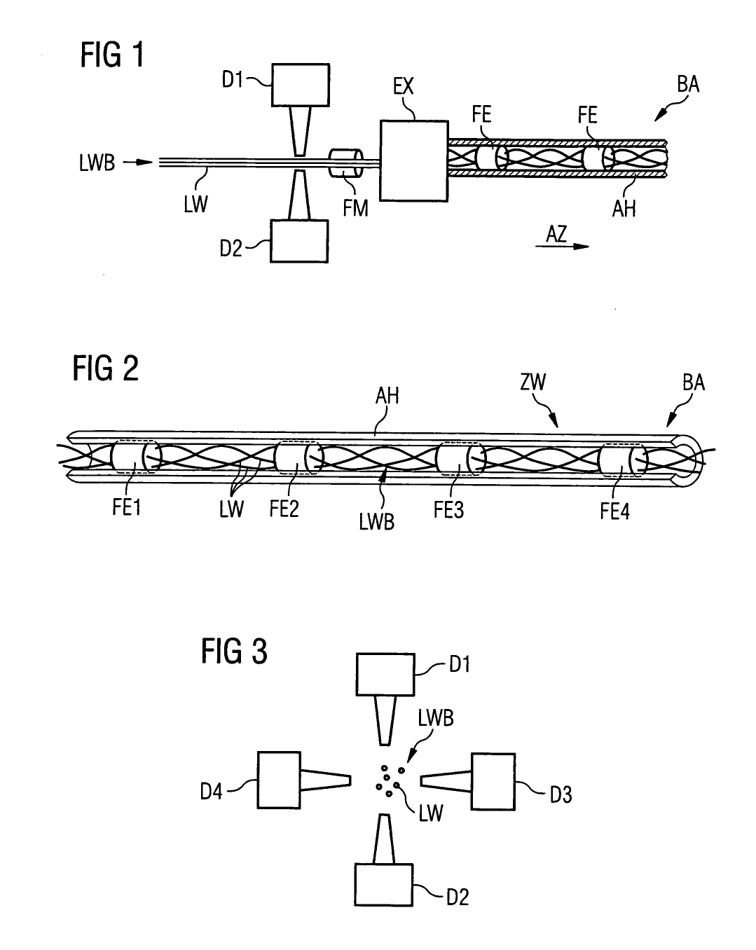

FIG. 1 shows a schematically illustrated production line by means of which an optical transmission element, in particular in the form of a bundle core, is produced according to the method according to the invention. A bundle of optical waveguides LW is supplied to an extruder EX. In accordance with this exemplary embodiment, a plurality of optical waveguides LW pass into an extruder EX for forming a chamber element, here in the form of a core sleeve AH. The optical waveguides LW are embodied in particular as optical fibers which are arranged in the end product as optical waveguide bundle or fiber bundle LWB within a bundle core BA with the core sleeve AH. An alternative embodiment provides, as optical waveguides LW, by way of example, optical cores each having a plurality of enclosed fibers, the cores being arranged as core strand within a cable sheath with the sleeve AH. The invention is furthermore described in more detail below on the basis of the first embodiment.

According to the invention, an already foamed filler composition FM is applied discontinuously to the optical waveguide bundle LWB by means of nozzles D1, D2. The optical waveguide bundle LWB is subsequently supplied to the extruder EX, the latter forming the core sleeve AH around the optical waveguides. The prefoamed filler composition FM stabilizes within the core sleeve AH formed by virtue of the supply of heat to the core sleeve and, in the final state, forms a respective cured, dry but still compressible filler element FE, which in each case surrounds the optical waveguides. In particular filler compositions based on foamed polyurethanes or silicones are suitable in this case. Two nozzles D1 and D2 are used which apply the foamed filler composition FM uniformly to the optical waveguides LW approximately concentrically and in the radial direction of the transmission element.

The nozzles D1, D2 are arranged opposite one another and enclose the optical waveguides LW between them. Piezocontrolled valves are preferably used as nozzles in order to realize the regulation of the application quantities and the short cycle times during application (approximately 1 ms per filler element to be formed) at a comparatively high take-off speed. The application quantity, opening time and the repetition frequency are adapted depending on the take-off speed in the take-off direction AZ of the bundle core BA. The distance between the filler elements FE and the size thereof can be set individually. The length and size of the filler elements FE are regulated by way of opening time, valve stroke and material pressure. The optical waveguides LW are guided accurately in this case in order to prevent axial oscillations.

During the stabilization process of the filler composition FM, the cross section of the initially still hot core sleeve AH is not altered by the filler composition FM. For this purpose, the foamed filler composition FM, upon introduction into the extruder EX, preferably has a diameter that is approximately equal to an internal diameter of the core sleeve AH. This is regulated in particular by way of the application quantity. The foamed filler composition FM expands only slightly after introduction into the extruder EX in the stabilization process, in order to produce a positively locking fit with respect to the core sleeve AH.

Preferably, the foamed filter composition FM expands by approximately 10 percent of its volume after introduction into the extruder EX.

In the final state, the foamed, stabilized filler composition FM forms a filler element FE which exerts a defined press-on force against the core sleeve AH and against the optical waveguides WL in order to fix the same in the longitudinal direction of the bundle core BA, positional changes of the optical waveguides LW nevertheless being made possible. By means of the filler composition FM, existing interspaces between the optical waveguides LW in the cross-sectional plane of the bundle core BA are also filled and permeated, and contact is made with the optical waveguides LW and the core sleeve AH essentially in a positively locking manner, so that a fixed connection arises in each case.

FIG. 2 shows a longitudinal section through a transmission element BA according to the invention in the final state. Filler composition FM applied discontinuously to the optical waveguides LW in accordance with FIG. 1 forms a plurality of dry and compressible filler elements FE1 to FE4 which surround the optical waveguides LW and fill and permeate existing interspaces between the optical waveguides in the cross-sectional plane of the bundle core BA. Intervening interspaces ZW that are not occupied by filler elements are arranged between the filler elements FE1 to FE4. A dry bundle core BA thus arises, in the internal space of which are arranged filler elements FE1 to FE4 which function as partitions and produce an effective longitudinal watertightness of the bundle core. In order to support this property, the filler elements FE1 to FE4 may additionally contain an agent that is swellable in the event of ingress of water, in order to provide sealing against penetrating water.

FIG. 3 illustrates a further embodiment of a device for the production of an optical transmission element according to the method according to the invention, in cross section. In this case, more than two, in particular four, nozzles D1 to D4 are used which are arranged in a star-type fashion in the radial direction of the bundle core and enclose the optical waveguides LW between them. The diameter of the filler elements can thus be set even more precisely.

The application of the filler composition, which forms the later filler elements, to the arriving optical waveguides upstream of the extruder has the advantage that the precise metering is simplified considerably. Suitable nozzles can be brought directly into the vicinity of the optical waveguides upstream of the extruder. Downstream of the extruder this is only possible within a hollow tube and can be realized only with difficulty technically owing to the small dimensions.

The discontinuously provided and foamed filler composition makes only a small weight contribution to the finished transmission element. It is configured in such a way that it can be easily and completely stripped from the optical waveguides without the use of additional tools. It thus facilitates the laying and preparation of a cable. The filler composition is configured such that it closes off in watertight fashion the cavities within the fiber bundle and between fiber and chamber wall in the cross-sectional plane of the bundle core, but permits the fibers to be drawn easily through it. The fibers are clean and without residues and can immediately be used for further assembly (splicing, placement in cartridges) without additional cleaning steps.

1. A method for the production of an optical transmission element comprising at least one optical waveguide and comprising a chamber element surrounding the optical waveguide and enclosing an internal space,—in which a filler composition in a foamed state is applied discontinuously to the optical waveguide,—the optical waveguide is subsequently supplied to an extruder, the latter forming a chamber element around the optical waveguide,—in which the filler composition stabilizes within the chamber element formed and, in the final state, forms a plurality of dry compressible filler elements, each surrounding the optical waveguide.

2. The method as claimed in claim 1, wherein foamed polyurethanes or silicones are used as filler composition.

3. The method as claimed in claim 1 or 2, wherein during the stabilization process of the filler composition, the cross section of the chamber element is not altered by the filler composition.

4. The method as claimed in claim 1, the foamed filler composition, upon introduction into the extruder has a diameter that is approximately equal to an internal diameter of the chamber element.

5. The method as claimed in claim 1, wherein the foamed filler composition expands after introduction into the extruder in order to produce a positively locking fit with respect to the chamber element.

6. The method as claimed in claim 5, wherein the foamed filler composition expands by approximately 10 percent of its volume after introduction into the extruder.

7. The method as claimed in claim 1, wherein at least two nozzles are used which apply the foamed filler composition uniformly to the optical waveguide approximately concentrically and in the radial direction of the transmission element.

8. The method as claimed in claim 7, wherein the nozzles are arranged opposite one another and enclose the optical waveguide between them.

9. The method as claimed in claim 7, wherein more than two nozzles are used which are arranged in star-type fashion in the radial direction of the transmission element and enclose the optical waveguide between them.

10. The method as claimed in claim 7, wherein piezocontrol valves are used as nozzles.

11. An optical transmission element comprising at least one optical waveguide and comprising a chamber element surrounding the optical waveguide and enclosing an internal space,—comprising a plurality of dry and compressible filler elements, which are arranged in the internal space and are formed by prefoamed material, the filler elements exerting a defined press-on force against the chamber element and against the optical waveguide in order to fix the same in the longitudinal direction of the transmission element,—in which the filler elements in each case surround the optical waveguide, fill existing interspaces in the cross-sectional plane of the transmission element, and make contact with the optical waveguide and the chamber element in a form-fitting manner.

12. The optical transmission element as claimed in claim 11, wherein the material of the filler elements is formed by prefoamed polyurethanes or by silicones.

13. The optical transmission element as claimed in claim 11, wherein a plurality of separate filler elements are arranged in the longitudinal direction of the optical transmission element with intervening interspaces not occupied by filler elements.

14. The optical transmission element as claimed in claim 11, wherein the filler elements contain an agent that is swellable upon ingress of water, for sealing purposes.

15. The optical transmission element as claimed in claim 11, wherein the filler elements are configured in such a way that they can be easily and completely stripped from the optical waveguides without the use of additional tools.
